(19) United States
(12) Patent Application Publication
(10) Pub. No.: US 2026/0085564 A1
(43) Pub. Date: Mar. 26, 2026

(54) CHARGE PORT DOOR SYSTEM

(71) Applicants: Hyundai Motor Company, Seoul (KR); Kia Corporation, Seoul (KR); PHA Co., Ltd., Daegu (KR)

(72) Inventors: Sang Il Kim, Hwaseong-si (KR); Kyung Min Lee, Hwaseong-si (KR)

(21) Appl. No.: 19/091,274

(22) Filed: Mar. 26, 2025

(30) Foreign Application Priority Data
Sep. 24, 2024 (KR) 10-2024-0129275

(51) Int. Cl. E05F 15/603; E05D 15/56

(52) U.S. Cl. CPC E05F 15/603; E05D 15/56; E05Y 2201/702; E05Y 2900/534

(57) ABSTRACT

A charge port door system can include a housing, a door configured to rotate between a cover position in which the door covers the housing and an uncover position in which the door uncovers the housing, and to move between a retracted position in which the door comes into contact with the housing and an advanced position in which the door is advanced from the housing in a state in which the door is in the cover position, a door actuator fixed to the door, and including an actuator member configured to linearly move and rotate by a motor, and a guide housing fixed to the housing, and configured to receive the actuator member, wherein the actuator member includes a first guide groove extending straightly along a longitudinal direction thereof, and a second guide groove extending spirally from the first guide groove.

### CROSS-REFERENCE TO RELATED APPLICATIONS

This application is based on and claims the benefit of priority to Korean Patent Application No. 10-2024-0129275, filed on Sep. 24, 2024, in the Korean Intellectual Property Office, the disclosure of which is incorporated herein in its entirety by reference.

### TECHNICAL FIELD

The present disclosure relates to a charge port door system.

### BACKGROUND

An electric vehicle (EV) and a hybrid electric vehicle (HEV) may include a charge port for connecting an electric plug (charging plug) to the vehicle. The electric plug may be connected to a charging station supplying power to the vehicle. In addition, the EV and the HEV may include a charge port door system covering and uncovering the charge port.

The charge port door system may include a housing having an opening communicating with the charge port, a door movably mounted with respect to the housing, and an actuator configured to move the door. Types of the charge port door system according to the related art may include a gooseneck hinge-type charge port door system, a multilink-type charge port door system, and the like.

However, the related art charge port door system may fail to reliably open and close the door in a narrow space, which degrades the operability of the door. In a state in which the door is opened, the charging plug may interfere with the door, resulting in reduced product quality or marketability.

The above information described in this background section is provided to assist in understanding the background of the present disclosure, and may include technical information that is not considered as the prior art that is already publicly known, available, or in use.

### SUMMARY

The present disclosure relates to a charge port door system, and more particularly, to a charge port door system designed to stably guide the movement of a door, thereby reliably performing the opening and closing of the door.

An embodiment of the present disclosure can solve the above-mentioned problems occurring in the prior art while advantages achieved by the prior art are maintained intact.

An embodiment of the present disclosure can provide a charge port door system designed to stably guide the movement of a door, thereby reliably performing the opening and closing of the door, and to prevent a charging plug from interfering with the door in a state in which the door is opened.

According to an embodiment of the present disclosure, a charge port door system may include: a housing; a door configured to rotate between a cover position in which the door covers the housing and an uncover position in which the door uncovers the housing, and to move between a retracted position in which the door comes into contact with the housing and an advanced position in which the door is advanced from the housing in a state in which the door is in the cover position; a door actuator fixed to the door, and including an actuator member configured to linearly move and rotate by a motor; and a guide housing fixed to the housing, and configured to receive the actuator member. The actuator member may include a first guide groove extending straightly along a longitudinal direction thereof, and a second guide groove extending spirally from the first guide groove, and the first guide groove and the second guide groove may be provided in an outer surface of the actuator member. The guide housing may include a guide projection received in the first guide groove and the second guide groove.

The actuator member may further include an attachment portion fixed to the door.

The attachment portion may include an attachment plate fixed to the door, and a plurality of bosses provided on edges of the attachment plate. Each boss may have a hole defined in the center thereof, and the plurality of bosses may be fixed to the door through a plurality of fasteners.

The hole of at least one of the plurality of bosses may have a slot shape.

The guide housing may further include a cylindrical portion, an attachment plate provided on the cylindrical portion, and a plurality of bosses provided on the attachment plate. Each boss may have a hole defined in the center thereof, and the plurality of bosses may be fixed to the housing through a plurality of fasteners.

The hole of at least one of the plurality of bosses may have a slot shape.

The actuator member may be configured to move between a first position, a second position, and a third position. The door may be in the retracted position when the actuator member is in the first position, the door may be in the advanced position when the actuator member is in the second position, and the door may be in the uncover position when the actuator member is in the third position.

When the actuator member moves between the first position and the second position, the actuator member may be guided to move linearly by the first guide groove and the guide projection, and when the actuator member moves between the second position and the third position, the actuator member may be guided to rotate around a central axis thereof by the second guide groove and the guide projection.

The door actuator may further include an actuator housing receiving the motor, and a guide sleeve extending from the actuator housing toward the door. The guide sleeve may be received in the guide housing, and the actuator member may be movably received in the guide sleeve.

The outer surface of the actuator member may be configured to match an inner surface of the guide sleeve.

The door actuator may further include a lead screw rotated by the motor. The lead screw may have an external thread on an outer peripheral surface thereof, and the actuator member may have an internal thread meshing with the external thread of the lead screw.

The door actuator may further include a transmission mechanism configured to transmit a torque of the motor to the lead screw.

The door actuator may further include an operating gear configured to transmit the torque from the transmission mechanism to the lead screw.

The operating gear may be fixed to the lead screw.

### BRIEF DESCRIPTION OF THE DRAWINGS

The above and other features and advantages of the present disclosure can be more apparent from the following detailed description taken in conjunction with the accompanying drawings:

FIG. 1 illustrates an exploded perspective view of a door and a housing in a charge port door system according to an example embodiment of the present disclosure, which is viewed from the outside of a vehicle;

FIG. 2 illustrates an exploded perspective view of a door and a housing in a charge port door system according to an example embodiment of the present disclosure, which is viewed from the interior of a vehicle;

FIG. 3 illustrates a housing of a charge port door system according to an example embodiment of the present disclosure, which is viewed from the outside of a vehicle;

FIG. 4 illustrates a housing of a charge port door system according to an example embodiment of the present disclosure, which is viewed from the interior of a vehicle;

FIG. 5 illustrates a perspective view of an actuator member in a charge port door system according to an example embodiment of the present disclosure;

FIG. 6 illustrates a perspective view of a guide housing in a charge port door system according to an example embodiment of the present disclosure;

FIG. 7 illustrates a view, which is viewed in the direction of arrow A of FIG. 6;

FIG. 8 illustrates a perspective view of a state in which support projections of a guide housing are inserted into openings of an attachment portion of an actuator member in a charge port door system according to an example embodiment of the present disclosure;

FIG. 9 illustrates an exploded perspective view of a door actuator in a charge port door system according to an example embodiment of the present disclosure;

FIG. 10 illustrates a side cross-sectional view of a door actuator in a charge port door system according to an example embodiment of the present disclosure;

FIG. 11 illustrates a cross-sectional view, taken along line B-B of FIG. 10;

FIG. 12 illustrates a cross-sectional view, taken along line C-C of FIG. 10;

FIG. 13 illustrates a state in which an actuator member is in a first position in a charge port door system according to an example embodiment of the present disclosure;

FIG. 14 illustrates a state in which an actuator member is in a second position in a charge port door system according to an example embodiment of the present disclosure;

FIG. 15 illustrates a state in which an actuator member is in a third position in a charge port door system according to an example embodiment of the present disclosure;

FIG. 16 illustrates a state in which a door is closed by a backward movement of an actuator member in a charge port door system according to an example embodiment of the present disclosure;

FIG. 17 illustrates a view, which is viewed in the direction of arrow D of FIG. 16;

FIG. 18 illustrates a state in which a door is advanced from a housing by a forward movement of an actuator member in a charge port door system according to an example embodiment of the present disclosure;

FIG. 19 illustrates a state in which a door rotates to the outside of a housing by a rotation of an actuator member in a charge port door system according to an example embodiment of the present disclosure; and

FIG. 20 illustrates a view, which is viewed in the direction of arrow E of FIG. 19.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate the same or equivalent elements. A detailed description of well-known techniques associated with the present disclosure can be omitted to not unnecessarily obscure the gist of the present disclosure.

Terms such as “first,” “second,” “A,” “B,” “(a),” and “(b)” may be used to describe the elements in example embodiments of the present disclosure. These terms can be used merely to distinguish one element from another element, and the intrinsic features, sequence or order, and the like of the corresponding elements are not limited by these terms. Unless otherwise defined, terms used herein, including technical or scientific terms, can have same meanings as those generally understood by those with ordinary knowledge in the field of art to which the present disclosure belongs. Such terms as those defined in a generally used dictionary can be interpreted as having meanings equal to the contextual meanings in the relevant field of art.

A charge port door system 10 may be configured to cover and uncover a charge port of a vehicle. The charge port may be configured to connect an electric plug (charging plug) to the vehicle (an electric vehicle (EV), a hybrid electric vehicle (HEV), and the like), and the electric plug may be connected to a charging station supplying power to the vehicle. The charge port door system 10 may be mounted in an opening of a vehicle body where the charge port is disposed, and the charge port door system 10 may have an exterior surface facing the exterior of the vehicle, and an interior surface facing the interior of the vehicle.

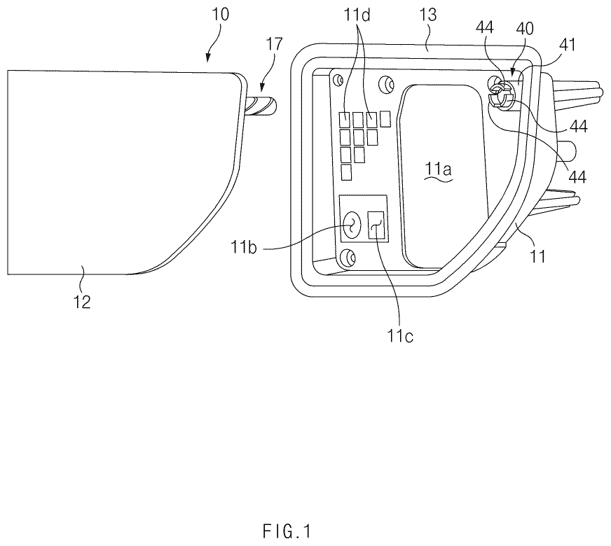

Referring to FIG. 1, the charge port door system 10 according to an example embodiment of the present disclosure may include a housing 11, and a door 12 which is movable relative to the housing 11.

The housing 11 may be disposed to enclose the charge port (not shown) of the vehicle. The housing 11 may have an exterior surface facing the exterior of the vehicle, and an interior surface facing the interior of the vehicle. When the door 12 is closed, the exterior surface of the housing 11 may be covered by the door 12, and when the door 12 is opened, the exterior surface of the housing 11 may be exposed to the outside of the vehicle.

The housing 11 may have a shape of a container recessed toward the interior of the vehicle. Referring to FIG. 1, the housing 11 may have a main opening 11a communicating with the charge port (not shown). The housing 11 may have a plurality of button openings 11b and 11c and a plurality of LED openings 11d. A seal 13 may extend along edges of the housing 11, and the seal 13 may seal edges of the door 12 and the edges of the housing 11 when the door 12 is closed.

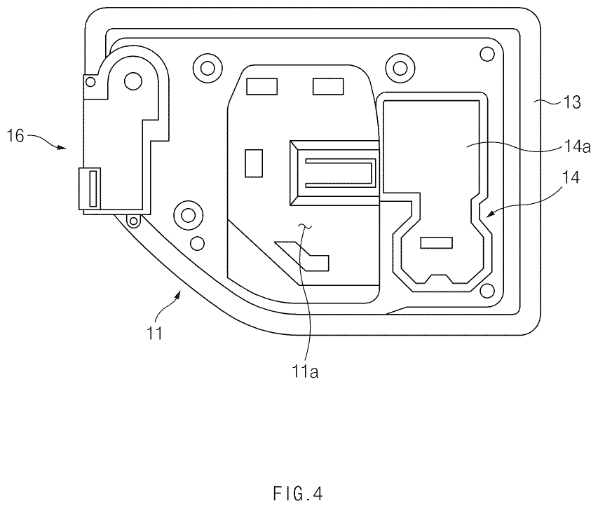

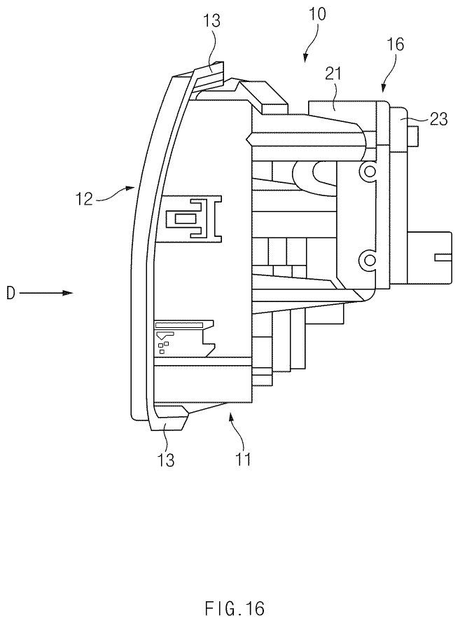

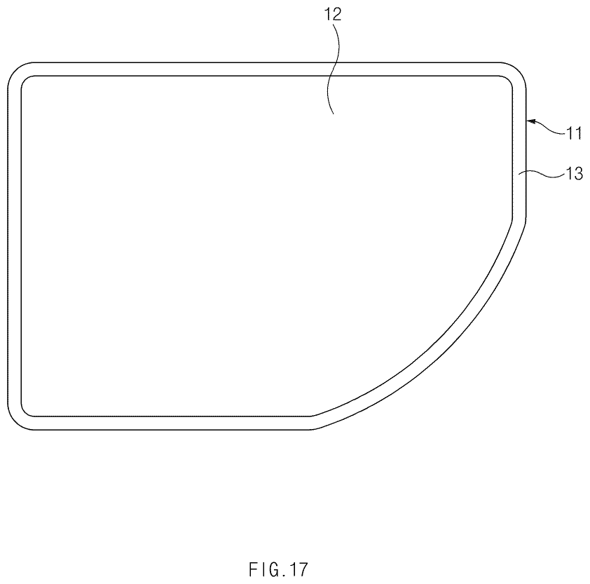

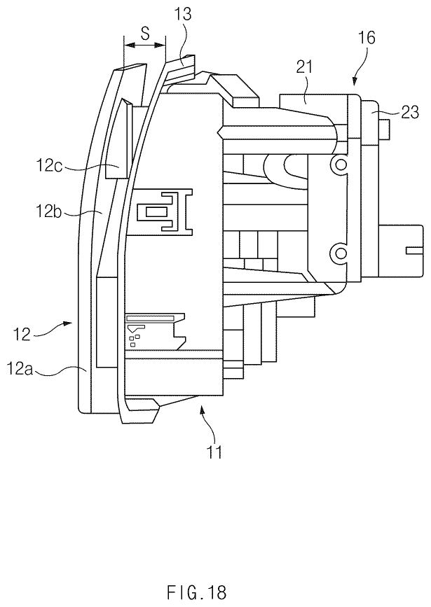

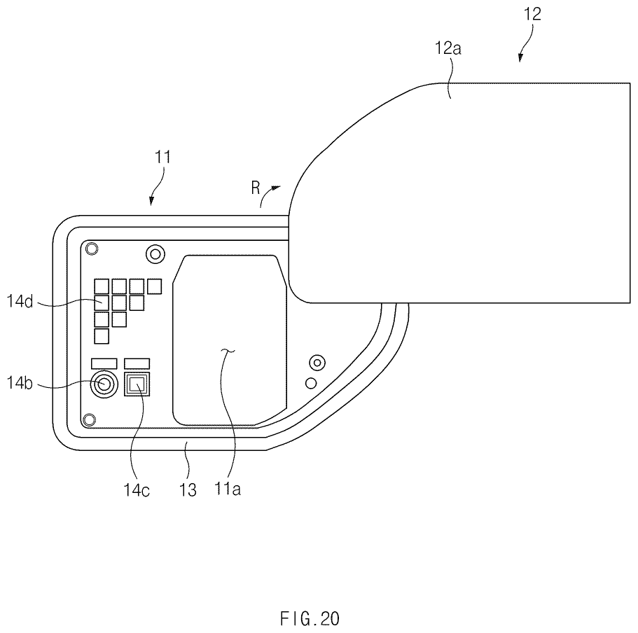

FIGS. 1-20 show various views and configurations of an example embodiment of the present disclosure, as described next. The door 12 may be configured to rotate by a door actuator 16 between a cover position (see FIG. 17) in which the door 12 covers the housing 11 and an uncover position (see FIG. 20) in which the door 12 uncovers the housing 11. When the door 12 is in the cover position, the door 12 may be configured to move linearly by the door actuator 16 between a retracted position (see FIG. 16) and an advanced position (see FIG. 18). Referring to FIG. 16, the retracted position refers to a position in which the door 12 comes into contact with the housing 11. Referring to FIG. 18, the advanced position refers to a position in which the door 12 is advanced from the housing 11 toward the outside of the vehicle so that the door 12 may be spaced apart from the housing 11 by a predetermined distance S.

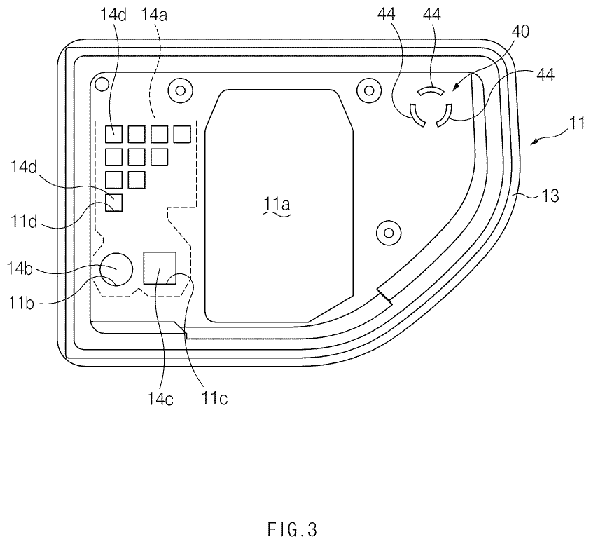

The charge port door system 10 according to an example embodiment of the present disclosure may include the door actuator 16 configured to move the door 12, and a switch assembly 14 configured to control/adjust the operation of the door actuator 16. Referring to FIG. 3, the switch assembly 14 and the door actuator 16 may be mounted on the interior surface of the housing 11.

The switch assembly 14 may be electrically connected to the door actuator 16 to be described below and a battery of the vehicle. Referring to FIG. 3, the switch assembly 14 may have a switch housing 14a, and a plurality of buttons 14b and 14c and a plurality of LEDs 14d provided on the switch housing 14a. The plurality of buttons 14b and 14c may include an opening button 14b for controlling the opening of the door 12 and a closing button 14c for controlling the closing of the door 12. The plurality of buttons 14b and 14c may be inserted into the button openings 11b and 11c of the housing 11, respectively, and the plurality of LEDs 14d may be inserted into the LED openings 11d of the housing 11, respectively. In a state in which the door 12 is opened, a user may directly press each of the buttons 14b and 14c so that the switch assembly 14 may be turned on. In a state in which the door 12 is closed, the user may press a portion of the door 12 corresponding to each of the buttons 14b and 14c, and accordingly each of the buttons 14b and 14c may be indirectly pressed through the door 12 so that the switch assembly 14 may be turned on. The plurality of LEDs 14d may be configured to display the charge amount and charge state of the vehicle battery.

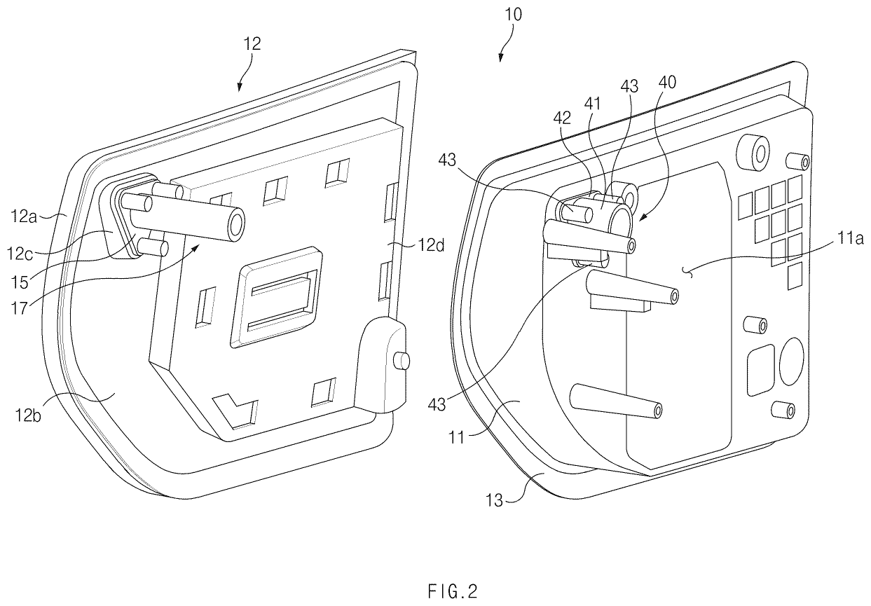

Referring to FIG. 2, the door 12 may include an outer panel 12a, and an inner panel 12b fixed to an interior surface of the outer panel 12a. The outer panel 12a may face the outside of the vehicle, and the inner panel 12b may face the interior of the vehicle. The outer panel 12a may be detachably attached to the inner panel 12b by a plurality of snap-fittings. A mounting portion 12c and a recessed portion 12d may be recessed from the inner panel 12b toward the housing 11.

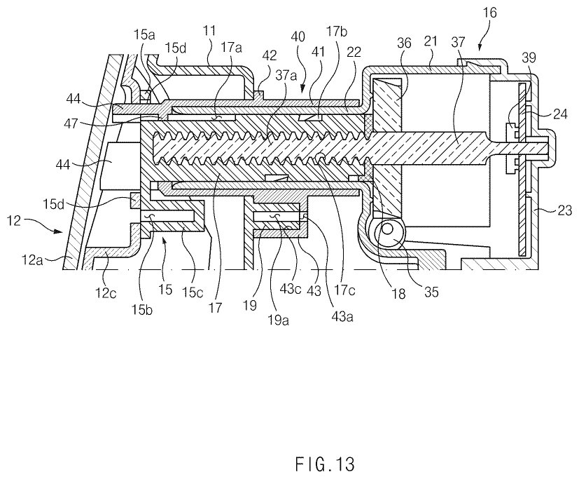

Referring to FIGS. 13 to 15, the door actuator 16 may include an actuator member 17 moving the door 12, and the actuator member 17 may extend through one edge of the housing 11 and be fixed to one edge of the door 12. The actuator member 17 may be configured to linearly move and rotate so that the door 12 may be advanced or retracted and rotate with respect to the housing 11. The actuator member 17 may include a first end portion facing the exterior of the vehicle, and a second end portion facing the interior of the vehicle. According to an example embodiment, the actuator member 17 may be made of an aluminum die-cast material, and accordingly stiffness of the actuator member 17 may be improved.

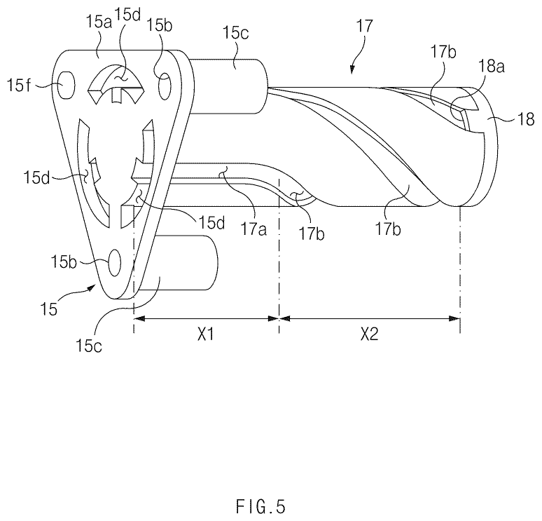

Referring to FIG. 2, the actuator member 17 may include an attachment portion 15 integrally connected to the first end portion thereof. The attachment portion 15 may be made of the same material as that of the actuator member 17, and the attachment portion 15 and the actuator member 17 may form a unitary one-piece structure. The attachment portion 15 of the actuator member 17 may be fixed to the door 12 through a fastener. Referring to FIG. 5, the attachment portion 15 may be fixed to the mounting portion 12c of the inner panel 12b of the door 12. The attachment portion 15 may include an attachment plate 15a integrally formed with the first end portion of the actuator member 17, and a plurality of bosses 15c provided on edges of the attachment plate 15a. Each boss 15c may have a hole 15b or 15f defined in the center thereof, and protrude from the attachment plate 15a toward the interior of the vehicle. A plurality of fasteners (screws and/or the like) may be screwed into the holes 15b and 15f of the bosses 15c, respectively, so that the attachment plate 15a of the attachment portion 15 may be fixed to the mounting portion 12c of the inner panel 12b of the door 12. Accordingly, the attachment portion 15 of the actuator member 17 may be fixed to the mounting portion 12c of the inner panel 12b of the door 12 through the plurality of bosses 15c. The actuator member 17 may be firmly fixed to the door 12 through the attachment portion 15 so that vibration, shaking, damage, and the like of the door 12 may be prevented while the door 12 is moving.

According to an example embodiment of the present disclosure, the hole 15f of at least one of the plurality of bosses 15c may have a slot shape, and the holes 15b of the other bosses 15c may have a circular shape. An attachment position between the attachment portion 15 of the actuator member 17 and the inner panel 12b of the door 12 may be relatively adjusted through the slot-shaped hole 15f. When a height difference, gap, or the like between the door 12 and the opening of the vehicle body is outside of a predetermined design value in a state in which the door 12 is closed, an operator may detach the outer panel 12a of the door 12 from the vehicle body, and appropriately adjust the attachment position between the attachment portion 15 and the inner panel 12b through the slot-shaped hole 15f.

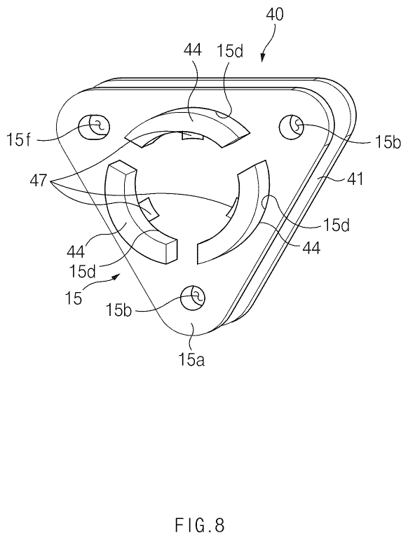

Referring to FIGS. 5 and 8, among the plurality of bosses 15c, the hole 15f of any one boss 15c may have a slot shape, and the holes 15b of the two bosses 15c may have a circular shape.

Referring to FIG. 5, the attachment portion 15 may have a plurality of openings 15d, each opening 15d may have an arc shape, and an inner peripheral surface of each opening 15d may be aligned with an outer peripheral surface of the actuator member 17. The plurality of openings 15d may be spaced apart from each other in a circumferential direction of the actuator member 17.

Referring to FIG. 5, the actuator member 17 may include a first guide groove 17a extending straightly along a longitudinal axis of the actuator member 17, and a second guide groove 17b extending spirally from the first guide groove 17a. The first guide groove 17a may extend straightly from the first end portion of the actuator member 17 toward the second end portion of the actuator member 17. The second guide groove 17b may extend spirally from the first guide groove 17a toward the second end portion of the actuator member 17. The first guide groove 17a and the second guide groove 17b may be formed continuously in the outer peripheral surface of the actuator member 17. The actuator member 17 may include a first section X1 in which the first guide groove 17a is formed, and a second section X2 in which the second guide groove 17b is formed. The first section X1 and the second section X2 may be arranged along a longitudinal direction of the actuator member 17. According to an example embodiment, the plurality of first guide grooves 17a may be formed in the first section X1, the plurality of second guide grooves 17b may be connected to the plurality of first guide grooves 17a, respectively, and the plurality of second guide grooves 17b may be formed in the second section X2.

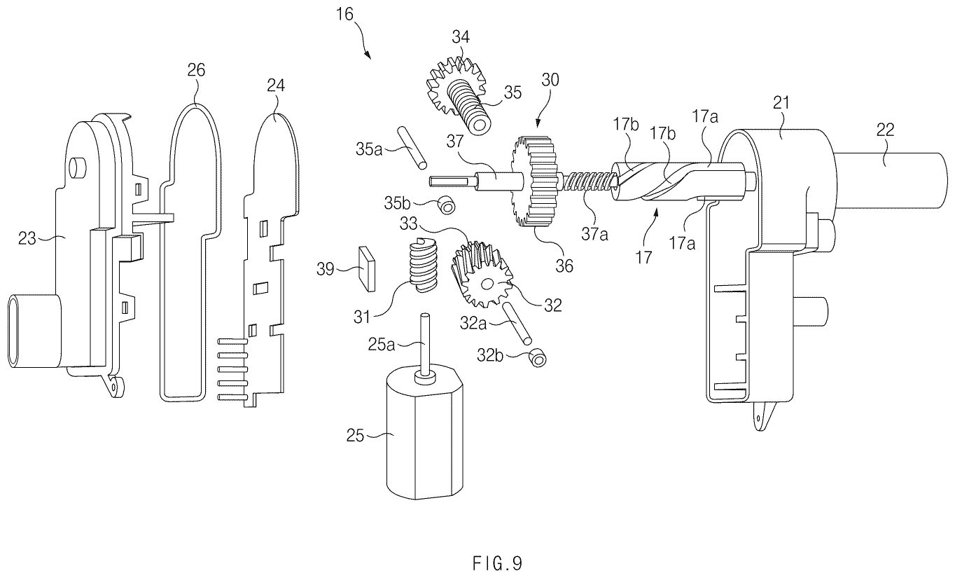

Referring to FIG. 9, the door actuator 16 may include an actuator housing 21, a motor 25 driving the actuator member 17, and a lead screw 37 rotated by the motor 25. The motor 25 and the lead screw 37 may be disposed in the actuator housing 21, and the actuator member 17 may be configured to linearly move and rotate by the rotation of the lead screw 37. The motor 25 may be a bi-directional motor rotating clockwise and counterclockwise. The lead screw 37 may have an external thread 37a on an outer peripheral surface thereof, and the lead screw 37 may extend to a predetermined length. The lead screw 37 may be configured to rotate around a central axis thereof. The actuator member 17 may be a lead nut having an internal thread 17c meshing with the external thread 37a of the lead screw 37. When the lead screw 37 is rotated by the motor 25 and a transmission mechanism 30, the actuator member 17 may move in a longitudinal direction of the lead screw 37.

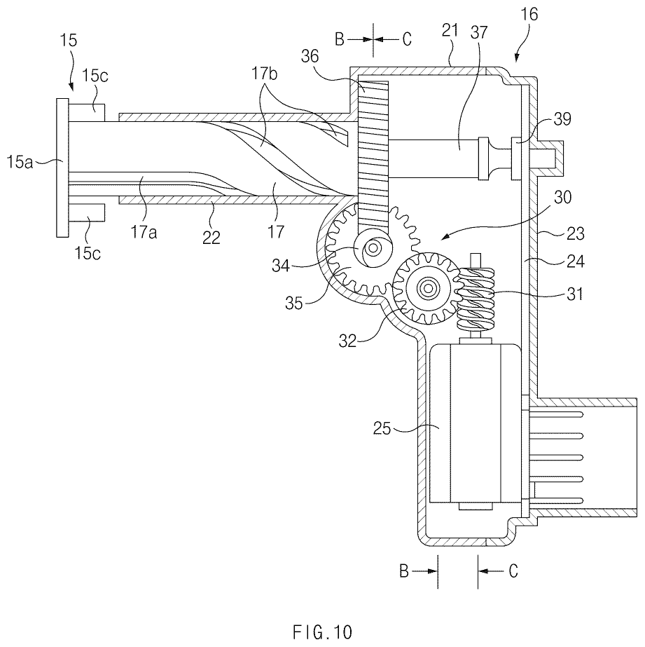

Referring to FIGS. 9 and 10, the transmission mechanism 30 may be disposed between the motor 25 and the lead screw 37. Referring to FIG. 9, the transmission mechanism 30 may be a gear train including an input gear 31 fixed to an output shaft 25a of the motor 25, a first transmission gear 32 meshing with the input gear 31, a second transmission gear 33 fixed to the first transmission gear 32, a third transmission gear 34 meshing with the second transmission gear 33, and a fourth transmission gear 35 fixed to the third transmission gear 34. As the first transmission gear 32 meshes with the input gear 31, a torque of the motor 25 may be transmitted to the first transmission gear 32, the second transmission gear 33, the third transmission gear 34, and the fourth transmission gear 35 through the input gear 31. A gear pin 32a may be inserted into the center of the first transmission gear 32 and the center of the second transmission gear 33, and an end of the gear pin 32a may be rotatably supported by a bush 32b. A gear pin 35a may be inserted into the center of the third transmission gear 34 and the center of the fourth transmission gear 35, and an end of the gear pin 35a may be rotatably supported by a bush 35b.

Referring to FIG. 10, a rotational axis of the input gear 31 may be aligned with a rotational axis of the output shaft 25a of the motor 25. A rotational axis of the first transmission gear 32 may be perpendicular to the rotational axis of the input gear 31. According to an example embodiment, the input gear 31 and the first transmission gear 32 may be a screw gear.

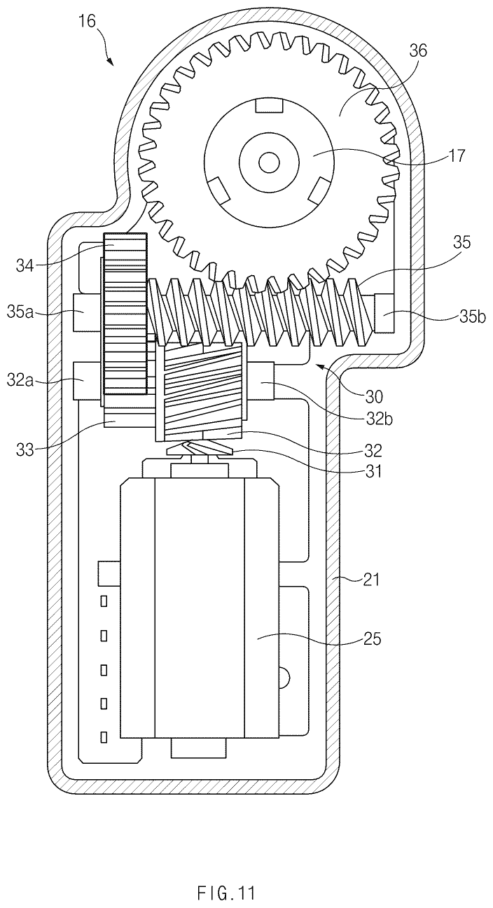

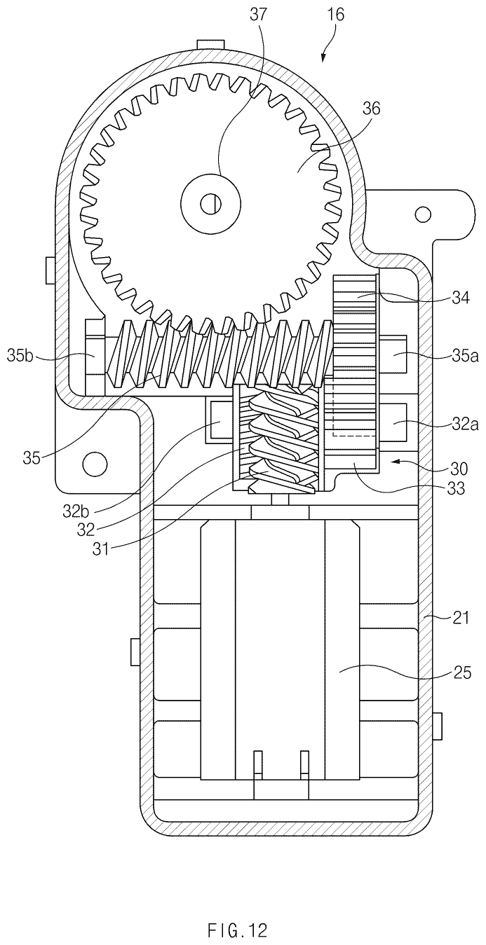

Referring to FIGS. 11 and 12, the second transmission gear 33 may be fixed to the first transmission gear 32 so that the second transmission gear 33 may rotate together with the first transmission gear 32 in the same direction. A rotational axis of the second transmission gear 33 may be aligned with the rotational axis of the first transmission gear 32. A diameter of the second transmission gear 33 may be the same as or be different from a diameter of the first transmission gear 32.

Referring to FIGS. 11 and 12, a rotational axis of the third transmission gear 34 may be parallel to the rotational axis of the second transmission gear 33. According to an example embodiment, the second transmission gear 33 and the third transmission gear 34 may be a spur gear or a helical gear.

Referring to FIGS. 11 and 12, the fourth transmission gear 35 may be fixed to the third transmission gear 34 so that the fourth transmission gear 35 may rotate together with the third transmission gear 34 in the same direction. A rotational axis of the fourth transmission gear 35 may be aligned with the rotational axis of the third transmission gear 34. A diameter of the fourth transmission gear 35 may be less than a diameter of the third transmission gear 34.

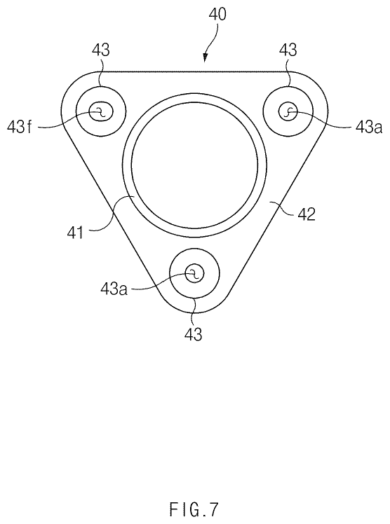

Referring to FIG. 7, the door actuator 16 may further include an operating gear 36 transmitting a torque from the transmission mechanism 30 to the lead screw 37. The operating gear 36 may be fixed to the lead screw 37 so that the lead screw 37 may rotate together with the operating gear 36 in the same direction. According to an example embodiment, the operating gear 36 and the lead screw 37 may form a unitary one-piece structure. As the operating gear 36 and the lead screw 37 form a unitary one-piece structure, vibration, shaking, and the like between the operating gear 36 and the lead screw 37 may be prevented. The operating gear 36 may be operatively connected to the transmission mechanism 30, and a rotational axis of the operating gear 36 may be aligned with a rotational axis of the lead screw 37. Specifically, the operating gear 36 may mesh with the fourth transmission gear 35 of the transmission mechanism 30, and the torque of the motor 25 may be transmitted from the transmission mechanism 30 to the operating gear 36 so that the operating gear 36 may rotate around the rotational axis thereof, and the lead screw 37 may rotate together with the operating gear 36 in the same direction.

According to an example embodiment, a central axis of the operating gear 36 may be perpendicular to a central axis of the fourth transmission gear 35, the fourth transmission gear 35 may be a worm gear, and the operating gear 36 meshing with the fourth transmission gear 35 may be a worm wheel.

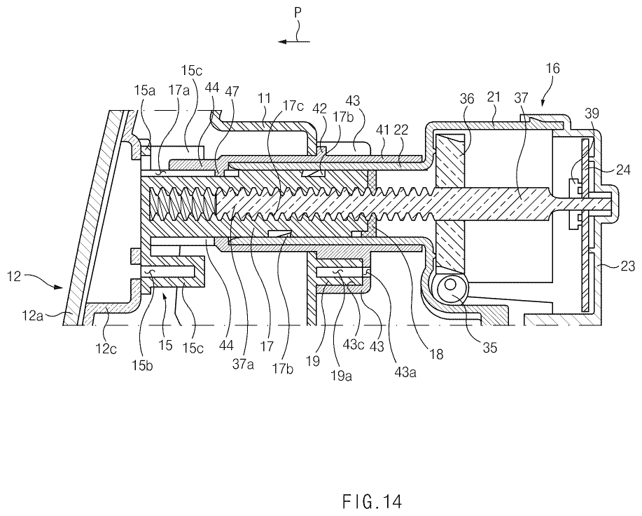

The second end portion of the actuator member 17 may face the actuator housing 21 of the door actuator 16. Referring to FIGS. 13 and 14, as the actuator member 17 moves by the rotation of the lead screw 37, the second end portion of the actuator member 17 may move close to or move away from the operating gear 36, and the door 12 may move together with the actuator member 17.

Referring to FIG. 9, a cover 23 may be joined to the actuator housing 21 by a plurality of snap fittings, and the actuator housing 21 and the cover 23 may define a cavity. A seal 26 may be interposed between edges of the actuator housing 21 and edges of the cover 23 so that the actuator housing 21 and the cover 23 may be sealed by the seal 26. A printed circuit board (PCB) 24, the motor 25, the transmission mechanism 30, and the lead screw 37 may be disposed in the cavity defined by the actuator housing 21 and the cover 23.

Referring to FIG. 9, the door actuator 16 may further include a sensor 39 configured to detect the position of the door 12. The sensor 39 may be mounted on the PCB 24. The sensor 39 may sense a rotational position of any one of the output shaft 25a of the motor 25, the input gear 31, and the lead screw 37 to detect the position of the door 12.

Referring to FIGS. 10, 13, 14, and 15, the sensor 39 may be configured to sense the rotational position of the lead screw 37. For example, the sensor 39 may include a rotating portion which is fixed to the lead screw 37, and a sensing portion which senses the rotational position of the rotating portion. A controller (not shown) may calculate a moving range (distance) of the actuator member 17 using the rotational position of the lead screw 37 sensed by the sensor 39 and a pitch of the external thread 37a of the lead screw 37 so that the position of the door 12 may be accurately detected.

Referring to FIG. 9, the door actuator 16 may include a guide sleeve 22 extending to a predetermined length from the actuator housing 21. The guide sleeve 22 may include a first end portion facing the exterior of the vehicle, and a second end portion facing the interior of the vehicle. Referring to FIGS. 13, 14, and 15, the guide sleeve 22 may extend from the actuator housing 21 toward the door 12, the actuator member 17 may be movably received in the guide sleeve 22, and the guide sleeve 22 may be configured to guide the linear movement and rotation of the actuator member 17. The actuator member 17 may have a cylindrical shape with a predetermined outer diameter, and the guide sleeve 22 may have a cylindrical shape with an inner diameter corresponding to the outer diameter of the actuator member 17. Because the outer diameter of the actuator member 17 can be slightly less than or equal to the inner diameter of the guide sleeve 22, the outer surface of the actuator member 17 may match an inner surface of the guide sleeve 22. Accordingly, while the actuator member 17 is moving and rotating in the guide sleeve 22, vibration, shaking, and the like of the actuator member 17 may be prevented.

According to an example embodiment of the present disclosure, as the operating gear 36 can be fixed to the lead screw 37, the actuator member 17 may be mounted on the lead screw 37, and then the actuator member 17 and the lead screw 37 may be mounted in the actuator housing 21. Thereafter, the first end portion of the actuator member 17 may be attached to the inner panel 12b of the door 12 through the attachment portion 15. As described above, the actuator member 17 and the lead screw 37 may be preassembled, and the actuator member 17 and the lead screw 37 may be mounted in the actuator housing 21, and then the actuator member 17 may be mounted on the door 12 so that an assembly process thereof may not only be simplified but also be smoothly and stably performed.

The charge port door system 10 according to an example embodiment of the present disclosure may include a guide housing 40 configured to receive the guide sleeve 22 and the actuator member 17. The guide housing 40 may extend through an opening of the housing 11, and the guide housing 40 may be fixed to the housing 11. The guide housing 40 may include a first end portion facing the exterior of the vehicle, and a second end portion facing the interior of the vehicle. The actuator member 17 may be received in the guide sleeve 22 of the door actuator 16, the guide sleeve 22 may be received in the guide housing 40, and the guide housing 40 may be fixed to the housing 11 so that support stiffness of the actuator member 17 and the door 12 may be improved, and accordingly the door 12 may be stably supported against various adverse conditions and any external shocks.

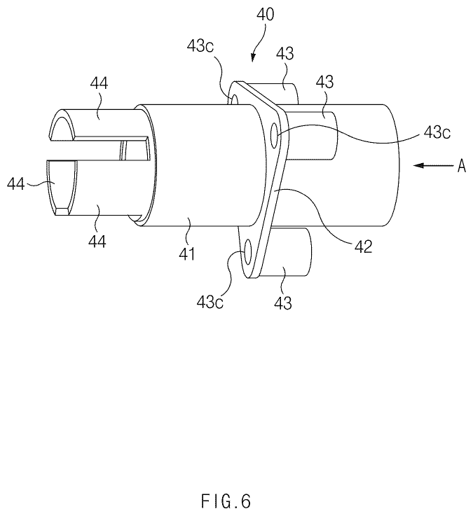

Referring to FIG. 6, the guide housing 40 may include a cylindrical portion 41, an attachment plate 42 provided on the middle of the cylindrical portion 41, and a plurality of bosses 43 provided on the attachment plate 42.

The cylindrical portion 41 may include a first end portion facing the exterior of the vehicle, and a second end portion facing the interior of the vehicle. The cylindrical portion 41 may extend through the opening of the housing 11, and the cylindrical portion 41 may be configured to receive the guide sleeve 22 of the door actuator 16. The cylindrical portion 41 may have a cylindrical shape with an inner diameter corresponding to an outer diameter of the guide sleeve 22. Because the inner diameter of the cylindrical portion 41 can be slightly greater than or equal to the outer diameter of the guide sleeve 22, an outer surface of the guide sleeve 22 may match an inner surface of the cylindrical portion 41. Accordingly, support stiffness of the guide sleeve 22 of the door actuator 16 with respect to the cylindrical portion 41 of the guide housing 40 may be improved. As the guide sleeve 22 of the actuator housing 21 is received in the cylindrical portion 41 of the guide housing 40, the actuator member 17 may move and rotate through the guide sleeve 22 and the cylindrical portion 41 of the guide housing 40. When the actuator member 17 moves and rotates through the guide sleeve 22 and the cylindrical portion 41 of the guide housing 40, the vibration, shaking, and the like of the actuator member 17 may be prevented.

The attachment plate 42 may be fixed to the interior surface of the housing 11 through the plurality of bosses 43.

The plurality of bosses 43 may be provided on edges of the attachment plate 42, and the plurality of bosses 43 may protrude from the attachment plate 42 toward the interior of the vehicle.

Referring to FIGS. 13, 14, and 15, each boss 43 of the guide housing 40 may have a recess 43c, and the housing 11 may have a plurality of projections 19 protruding from the interior surface thereof toward the interior of the vehicle. Each projection 19 of the housing 11 may be inserted into the recess 43c of each boss 43 of the guide housing 40.

Each boss 43 may have a hole 43a or 43f defined in the center thereof, and each projection 19 of the housing 11 may have a hole 19a aligned with the hole 43a or 43f of each boss 43. A fastener (a screw and/or the like) may be screwed into the hole 43a or 43f of each boss 43 and the hole 19a of the corresponding projection 19 so that the attachment plate 42 of the guide housing 40 may be fixed to the interior surface of the housing 11. Accordingly, the attachment plate 42 of the guide housing 40 may be fixed to the housing 11 through the plurality of bosses 43 so that the vibration, shaking, damage, and the like of the actuator member 17 may be prevented while the actuator member 17 is moving.

Referring to FIG. 7, among the plurality of bosses 43, the hole 43f of at least one boss 43 may have a slot shape, and the holes 43a of the other bosses 43 may have a circular shape. An attachment position between the attachment plate 42 of the guide housing 40 and the housing 11 may be relatively adjusted through the slot-shaped hole 43f.

When a height difference, gap, or the like between the door 12 and the opening of the vehicle body is outside of a predetermined design value in a state in which the door 12 is closed, the operator may detach the outer panel 12a of the door 12 from the vehicle body, and appropriately adjust the attachment position between the attachment portion 15 of the actuator member 17 and the inner panel 12b through the slot-shaped hole 15f. In relation to the adjustment of the attachment position of the attachment portion 15 of the actuator member 17 with respect to the inner panel 12b, the attachment position of the attachment plate 42 of the guide housing 40 may be adjusted with respect to the housing 11 through the slot-shaped hole 43f. Referring to FIG. 7, among the plurality of bosses 43, the hole 43f of any one boss 43 may have a slot shape, and the holes 43a of the two bosses 43 may have a circular shape.

Referring to FIGS. 13, 14, and 15, the guide housing 40 may have a guide projection 47 provided on an inner surface of the cylindrical portion 41, and the guide projection 47 may protrude from the inner surface of the cylindrical portion 41 toward the center of the cylindrical portion 41. The guide projection 47 may be received in the first guide groove 17a and the second guide groove 17b of the actuator member 17. Accordingly, the linear movement and rotation of the actuator member 17 may be guided by the guide projection 47 and the guide grooves 17a and 17b. According to an example embodiment, the guide projection 47 may be provided at the first end portion of the cylindrical portion 41 of the guide housing 40, and accordingly the guide projection 47 and the guide grooves 17a and 17b may guide the linear movement and rotation of the actuator member 17 over the entire length of the actuator member 17.

Referring to FIG. 8, when the plurality of first guide grooves 17a and the plurality of second guide grooves 17b are provided in the actuator member 17, the guide housing 40 may have the plurality of guide projections 47 corresponding to the plurality of first guide grooves 17a and the plurality of second guide grooves 17b.

Referring to FIG. 6, the guide housing 40 may have a plurality of support projections 44 protruding from the first end portion of the cylindrical portion 41 toward the exterior of the vehicle. Each support projection 44 may have an arc shape, and the plurality of support projections 44 may be spaced apart from each other in a circumferential direction of the cylindrical portion 41. Referring to FIG. 8, the support projections 44 of the guide housing 40 may be inserted into or released from the openings 15d of the attachment portion 15 of the actuator member 17, respectively.

Referring to FIG. 14, while the actuator member 17 is moving in the longitudinal direction of the lead screw 37 by the rotation of the lead screw 37, the first guide groove 17a of the actuator member 17 may be guided by the guide projection 47 of the guide housing 40 so that the actuator member 17 may move linearly along the first guide groove 17a. That is, when the lead screw 37 is rotated, and the actuator member 17 is guided by the first guide groove 17a and the guide projection 47, the actuator member 17 may move forward or backward in the longitudinal direction of the lead screw 37.

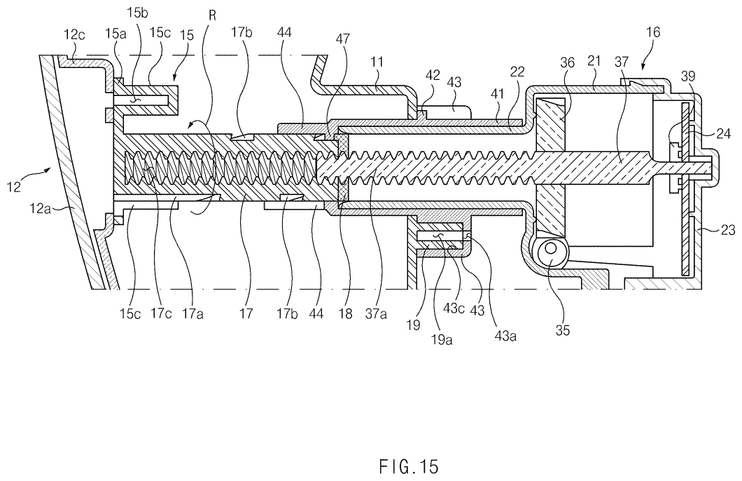

Referring to FIG. 15, while the actuator member 17 is moving in the longitudinal direction of the lead screw 37 by the rotation of the lead screw 37, the actuator member 17 may be guided by the second guide groove 17b and the guide projection 47 so that the actuator member 17 may move (rotate) spirally along the second guide groove 17b. As the rotation of the actuator member 17 is guided by the second guide groove 17b and the guide projection 47, the actuator member 17 may rotate around a central axis thereof.

The actuator member 17 may be configured to move by the rotation of the lead screw 37 between a first position (see FIG. 13), a second position (see FIG. 14), and a third position (see FIG. 15). When the actuator member 17 moves between the first position and the second position, the actuator member 17 may be guided to move linearly by the guide projection 47 and the first guide groove 17a. When the actuator member 17 moves between the second position and the third position, the actuator member 17 may be guided to rotate around the central axis thereof by the guide projection 47 and the second guide groove 17b.

Referring to FIGS. 13, 16, and 17, when the actuator member 17 is in the first position, the door 12 may be in the cover position and the retracted position so that the door 12 may be fully closed to cover the housing 11. Referring to FIGS. 14 and 18, when the actuator member 17 is in the second position, the door 12 may be in the cover position and the advanced position so that the door 12 may move forward from the housing 11 toward the outside of the vehicle, and accordingly the door 12 may be spaced apart from the housing 11. Referring to FIGS. 15, 19, and 20, when the actuator member 17 is in the third position, the door 12 may be in the uncover position to uncover the housing 11, and accordingly the door 12 may be opened.

As the motor 25 rotates, the torque of the motor 25 may be transmitted to the operating gear 36 and the lead screw 37 through the transmission mechanism 30. As the operating gear 36 and the lead screw 37 rotate, the actuator member 17 may move in the longitudinal direction of the lead screw 37.

Referring to FIG. 13, when the actuator member 17 is in the first position, the second end portion of the actuator member 17 may move close to the actuator housing 21, and the first end portion of the actuator member 17 may be aligned with the first end portion of the guide sleeve 22 of the actuator housing 21. When the actuator member 17 is in the first position, the entire edge of the door 12 may contact the seal 13 of the housing 11 as illustrated in FIGS. 16 and 17 so that the door 12 and the housing 11 may be sealed, and the door 12 may be fully closed to cover the housing 11.

When the user presses the door 12 in a state in which the door 12 is closed, the door 12 may press the opening button 14b, and the operating gear 36 and the lead screw 37 may rotate in a first direction by the motor 25 and the transmission mechanism 30 so that the actuator member 17 may move forward in the longitudinal direction of the lead screw 37 toward the outside of the vehicle (see the direction of arrow P in FIG. 14). Referring to FIG. 14, when the actuator member 17 moves forward by the rotation of the lead screw 37, the first guide groove 17a of the actuator member 17 may be linearly guided by the guide projection 47 of the guide housing 40 so that the actuator member 17 may move linearly along the first guide groove 17a toward the outside of the vehicle, and accordingly the actuator member 17 may be in the second position. When the actuator member 17 is in the second position, the second end portion of the actuator member 17 may move forward from the actuator housing 21, and the first end portion of the actuator member 17 may move forward from the first end portion of the guide sleeve 22 of the actuator housing 21 toward the outside of the vehicle. As the door 12 moves forward together with the actuator member 17, the door 12 may be advanced from the housing 11 toward the outside of the vehicle by a predetermined distance. When the actuator member 17 is in the second position, the door 12 may be advanced from the housing 11 toward the outside of the vehicle as illustrated in FIG. 18, and the entire edge of the door 12 may be spaced apart from the seal 13 of the housing 11 by a predetermined distance S.

Referring to FIG. 15, as the operating gear 36 and the lead screw 37 continuously rotate in the first direction by the motor 25 and the transmission mechanism 30 in a state in which the actuator member 17 is in the second position, the actuator member 17 may move from the second position toward the third position by the rotation of the lead screw 37. When the actuator member 17 moves from the second position to the third position, the second guide groove 17b of the actuator member 17 may be guided by the guide projection 47 of the guide housing 40 so that the actuator member 17 may move forward spirally along the second guide groove 17b toward the outside of the vehicle. Accordingly, the actuator member 17 may rotate around the central axis thereof (see the direction of arrow R in FIGS. 15 and 20). As illustrated in FIG. 20, as the door 12 rotates to the uncover position, the door 12 may be opened.

Referring to FIG. 13, when the actuator member 17 is in the first position, the support projections 44 of the guide housing 40 may be inserted into the openings 15d of the attachment portion 15. In a state in which the door 12 is closed, the door 12 may be stably supported by the support projections 44 of the guide housing 40 and the openings 15d of the attachment portion 15. Referring to FIGS. 14 and 15, when the actuator member 17 is in the second position and the third position, the support projections 44 of the guide housing 40 may be released from the openings 15d of the attachment portion 15, and accordingly the opening of the door 12 may be stably performed.

Referring to FIG. 5, the actuator member 17 may include a stopper 18 configured to restrict the movement of the actuator member 17. The stopper 18 may include a stopper projection 18a inserted into an end of the second guide groove 17b of the actuator member 17. When the actuator member 17 moves to the third position, the stopper 18 may prevent the actuator member 17 from being released from the guide sleeve 22 and the guide housing 40. The stopper 18 may be fixed to the second end portion of the actuator member 17. When the actuator member 17 moves forward to the third position, the stopper projection 18a may be stopped by the guide projection 47 to thereby prevent the actuator member 17 from being released from the guide sleeve 22 and the guide housing 40.

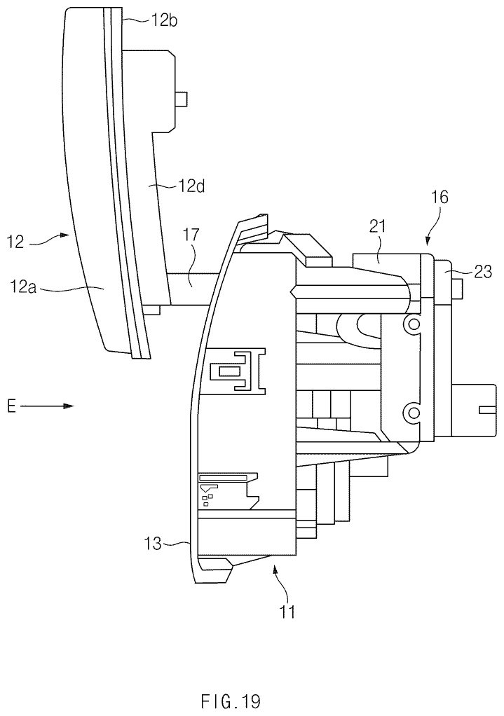

As illustrated in FIGS. 19 and 20, when the user presses the closing button 14c in a state in which the door 12 is opened, the operating gear 36 and the lead screw 37 may rotate in a second direction opposite to the first direction by the motor 25 and the transmission mechanism 30, and the actuator member 17 may move from the third position to the second position. When the actuator member 17 moves from the third position to the second position, the second guide groove 17b of the actuator member 17 may be guided by the guide projection 47 of the guide housing 40 so that the actuator member 17 may move backward spirally along the second guide groove 17b toward the second position. Accordingly, the actuator member 17 may rotate around the central axis thereof (in the direction opposite to the direction of arrow R in FIG. 15), and the door 12 may rotate to the cover position. As the operating gear 36 and the lead screw 37 continuously rotate in the second direction by the motor 25 and the transmission mechanism 30 in a state in which the actuator member 17 is in the second position, the actuator member 17 may move from the second position toward the first position by the rotation of the lead screw 37. When the actuator member 17 moves from the second position to the first position, the first guide groove 17a of the actuator member 17 may be continuously guided by the guide projection 47 of the guide housing 40 so that the actuator member 17 may move from the second position to the first position. When the actuator member 17 moves from the second position to the first position, the actuator member 17 may be linearly guided to the first position by the guide projection 47 and the first guide groove 17a. As the door 12 moves to the retracted position, the door 12 may come into contact with the seal 13 of the housing 11, and the door 12 may be fully closed.

As set forth above, the charge port door system according to example embodiments of the present disclosure may be designed to allow the door to move by the door actuator between the cover position in which the door covers the housing and the uncover position in which the door uncovers the housing, and to allow the door in the cover position to move between the retracted position in which the door comes into contact with the housing and the advanced position in which the door is advanced from the housing so that the opening and closing of the door may be smoothly performed even in a narrow space, and the charging plug may be prevented from interfering with the door in a state in which the door is opened.

According to example embodiments of the present disclosure, the attachment portion of the actuator member may have the plurality of bosses fixed to the door, and the hole of at least one of the plurality of bosses may have a slot shape. When the height difference, gap, or the like between the door and the opening of the vehicle body is outside of a predetermined design value in a state in which the door is closed, the operator may detach the outer panel of the door from the vehicle body, and appropriately adjust the attachment position between the attachment portion and the inner panel through the slot-shaped hole.

According to example embodiments of the present disclosure, the guide housing may have the plurality of bosses fixed to the housing, and the hole of at least one of the plurality of bosses may have a slot shape. When the height difference, gap, or the like between the door and the opening of the vehicle body is outside of a predetermined design value in a state in which the door is closed, the operator may detach the outer panel of the door from the vehicle body, and appropriately adjust the attachment position between the attachment portion of the actuator member and the inner panel through the slot-shaped hole. In relation to the adjustment of the attachment position of the attachment portion of the actuator member with respect to the inner panel, the attachment position of the attachment plate of the guide housing may be adjusted with respect to the housing through the slot-shaped hole.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. A charge port door system, comprising:
a housing;
a door configured to rotate between a cover position in which the door covers the housing and an uncover position in which the door uncovers the housing, and to move between a retracted position in which the door comes into contact with the housing and an advanced position in which the door is advanced from the housing in a state in which the door is in the cover position;
a door actuator fixed to the door, and including an actuator member configured to linearly move and rotate by a motor; and
a guide housing fixed to the housing, and configured to receive the actuator member,
wherein the actuator member comprises a first guide groove extending straightly along a longitudinal direction thereof, and a second guide groove extending spirally from the first guide groove,
wherein the first guide groove and the second guide groove are provided in an outer surface of the actuator member, and
wherein the guide housing includes a guide projection configured to be received in the first guide groove and the second guide groove.

2. The charge port door system according to claim 1, wherein the actuator member further comprises an attachment portion fixed to the door.

3. The charge port door system according to claim 2, wherein the attachment portion includes an attachment plate fixed to the door, and a plurality of bosses provided on edges of the attachment plate,
wherein each of the plurality of bosses has a hole defined in a center thereof, and
wherein the plurality of bosses are fixed to the door by a plurality of fasteners.

4. The charge port door system according to claim 3, wherein the hole of at least one of the plurality of bosses has a slot shape.

5. The charge port door system according to claim 1, wherein the guide housing comprises:
a cylindrical portion;
an attachment plate provided on the cylindrical portion; and
a plurality of bosses provided on the attachment plate,
wherein each of the plurality of bosses has a hole defined in a center thereof, and
wherein the plurality of bosses are fixed to the housing by a plurality of fasteners.

6. The charge port door system according to claim 5, wherein the hole of at least one of the plurality of bosses has a slot shape.

7. The charge port door system according to claim 1, wherein the actuator member is configured to move between a first position, a second position, and a third position,
such that the door is in the retracted position in response to the actuator member being in the first position,
such that the door is in the advanced position in response to the actuator member being in the second position, and
such that the door is in the uncover position in response to the actuator member being in the third position.

8. The charge port door system according to claim 7, wherein, in response to the actuator member moving between the first position and the second position, the actuator member is guided to move linearly by the first guide groove and the guide projection, and
wherein, in response to the actuator member moving between the second position and the third position, the actuator member is guided to rotate around a central axis thereof by the second guide groove and the guide projection.

9. The charge port door system according to claim 1, wherein the door actuator further includes an actuator housing receiving the motor, and a guide sleeve extending from the actuator housing toward the door,
wherein the guide sleeve is received in the guide housing, and
wherein the actuator member is movably received in the guide sleeve.

10. The charge port door system according to claim 9, wherein the outer surface of the actuator member is configured to match an inner surface of the guide sleeve.

11. The charge port door system according to claim 1, wherein the door actuator further includes a lead screw configured to be rotated by the motor,
wherein the lead screw has an external thread on an outer peripheral surface thereof, and
wherein the actuator member has an internal thread meshing with the external thread of the lead screw.

12. The charge port door system according to claim 11, wherein the door actuator further includes a transmission mechanism configured to transmit a torque of the motor to the lead screw.

13. The charge port door system according to claim 12, wherein the door actuator further includes an operating gear configured to transmit the torque from the transmission mechanism to the lead screw.

14. The charge port door system according to claim 13, wherein the operating gear is fixed to the lead screw.

15. A charge port door system, comprising:
a housing;
a guide housing fixed to the housing, wherein the guide housing includes a guide projection;
a door configured to cover a portion of the housing; and
a door actuator fixed to the door, wherein the door actuator comprises:
an electric motor,
an actuator member configured to linearly move and rotate by the electric motor,
wherein the guide housing is configured to receive the actuator member therein,
wherein the actuator member comprises a first guide groove extending straightly along a longitudinal direction thereof, and a second guide groove extending spirally from the first guide groove,
wherein the first guide groove and the second guide groove are provided in an outer surface of the actuator member,
wherein the guide projection is configured to be received in the first guide groove and the second guide groove, and
wherein the actuator member includes an internal threaded portion therein,
a lead screw including an external threaded portion on an outer peripheral surface thereof, wherein the lead screw is rotatably coupled to the electric motor and configured to be rotated by the electric motor, wherein the internal threaded portion of the actuator member meshes with and threadedly engages with the external threaded portion of the lead screw,
wherein the charge port door system is configured such that rotation of the lead screw by the electric motor can cause an actuator-member motion of the actuator member, whereby the actuator-member motion of the actuator member can drive a door motion of the door, whereby the door can move between a first retracted cover position, a second partially-outwardly-extended cover position, and a third rotated-outwardly-extended uncover position, wherein the housing is covered and sealed by the door in the first retracted cover position of the door, and wherein the housing is exposed and accessible in the third rotated-outwardly-extended uncover position of the door, and wherein the door is pivoted relative to the housing in the third rotated-outwardly-extended uncover position.

16. The charge port door system according to claim 15, wherein the actuator member further comprises an attachment portion fixed to the door, wherein the attachment portion includes an attachment plate fixed to the door, and a plurality of bosses provided on edges of the attachment plate,
wherein each of the plurality of bosses has a hole defined in a center thereof, and
wherein the plurality of bosses are fixed to the door by a plurality of fasteners.

17. The charge port door system according to claim 16, wherein the hole of at least one of the plurality of bosses has a slot shape.

18. The charge port door system according to claim 15, wherein the guide housing comprises:
a cylindrical portion;
an attachment plate provided on the cylindrical portion; and
a plurality of bosses provided on the attachment plate,
wherein each of the plurality of bosses has a hole defined in a center thereof, and
wherein the plurality of bosses are fixed to the housing by a plurality of fasteners.

19. The charge port door system according to claim 18, wherein the hole of at least one of the plurality of bosses has a slot shape.

20. A charge port door system, comprising:
a housing;
a guide housing fixed to the housing, wherein the guide housing includes a guide projection;
a door configured to cover a portion of the housing; and
a door actuator fixed to the door, wherein the door actuator comprises:
an electric motor,
an actuator member configured to linearly move and rotate by the electric motor,
wherein the guide housing is configured to receive the actuator member therein,
wherein the actuator member comprises a first guide groove extending straightly along a longitudinal direction thereof, and a second guide groove extending spirally from the first guide groove,
wherein the first guide groove and the second guide groove are provided in an outer surface of the actuator member,
wherein the guide projection is configured to be received in the first guide groove and the second guide groove, and
wherein the actuator member includes an internal threaded portion therein,
a lead screw including an external threaded portion on an outer peripheral surface thereof, wherein the lead screw is rotatably coupled to the electric motor and configured to be rotated by the electric motor, wherein the internal threaded portion of the actuator member meshes with and threadedly engages with the external threaded portion of the lead screw,
wherein the charge port door system is configured such that rotation of the lead screw by the electric motor can cause an actuator-member motion of the actuator member, whereby the actuator-member motion of the actuator member can drive a door motion of the door, whereby the door can move between a first retracted cover position, a second partially-outwardly-extended cover position, and a third rotated-outwardly-extended uncover position, wherein the housing is covered and sealed by the door in the first retracted cover position of the door, and wherein the housing is exposed and accessible in the third rotated-outwardly-extended uncover position of the door, and wherein the door is pivoted relative to the housing in the third rotated-outwardly-extended uncover position,
wherein the door actuator further includes an actuator housing receiving the electric motor, and a guide sleeve extending from the actuator housing toward the door,
wherein the guide sleeve is received in the guide housing,
wherein the actuator member is movably received in the guide sleeve, and
wherein the outer surface of the actuator member is configured to match an inner surface of the guide sleeve.
